(19) United States
(12) Patent Application Publication
(10) Pub. No.: US 2011/0099130 A1
(43) Pub. Date: Apr. 28, 2011

(54) Integrated learning for interactive synthetic characters

(75) Inventors: Bruce M. Blumberg, Concord, MA (US); Marc Norman Downie, Cambridge, MA (US); Yuri Ivanov, Arlington, MA (US); Matthew Roberts Berlin, Concord, MA (US)

(73) Assignee: Massachusetts Institute of Technology, Cambridge, MA (US)

(21) Appl. No.: 10/891,657

(22) Filed: Jul. 15, 2004

Related U.S. Application Data
(60) Provisional application No. 60/487,675, filed on Jul. 16, 2003.

(51) Int. Cl. G06F 15/18

(52) U.S. Cl. 706/12

(57) ABSTRACT

A practical approach to real-time learning for synthetic characters grounded in the techniques of reinforcement learning and informed by insights from animal training. The approach simplifies the learning task for characters by (a) enabling them to take advantage of predictable regularities in their world, (b) allowing them to make maximal use of any supervisory signals, and (c) making them easy to train by humans. An autonomous animated dog is described that can be trained with a technique used to train real dogs called “clicker training.”

### CROSS REFERENCE TO RELATED APPLICATIONS

This application is a Non-Provisional of U.S. patent application Ser. No. 60/487,675 filed on Jul. 16, 2003.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO COMPUTER PROGRAM LISTING APPENDIX

A computer program listing appendix is stored on each of two duplicate compact disks which accompany this specification. Each disk contains computer program listings which illustrate implementations of the invention. The listings are recorded as ASCII text in IBM PC/MS DOS compatible files which have the names, sizes (in bytes) and creation dates listed below:

| File Name | Bytes | Created | |
|---|---|---|---|
| AbstractMotorSystem.java | 2,069 | Mar. 18, 2002 | 08:46 PM |
| AbstractRoute.java | 3,657 | Mar. 27, 2002 | 08:10 PM |
| Action.java | 1,058 | Mar. 18, 2002 | 08:46 PM |
| ActionDataRecord.java | 1,139 | Mar. 18, 2002 | 08:46 PM |
| ActionGroupAction.java | 1,997 | Jul. 20, 2002 | 08:51 PM |
| ActionGroupActionTuple.java | 1,333 | Oct. 11, 2002 | 11:33 PM |
| ActionMotorBackwardStats.java | 5,756 | Jul. 03, 2002 | 05:05 PM |
| ActionStat.java | 1,678 | Mar. 18, 2002 | 08:46 PM |
| ActionSystem.java | 1,936 | May 31, 2002 | 03:15 PM |
| Add.java | 1,008 | Mar. 18, 2002 | 08:46 PM |
| AdditivePose.java | 13,580 | Mar. 27, 2002 | 08:10 PM |
| AdditivePoseMetrics.java | 3,981 | Mar. 27, 2002 | 08:10 PM |
| AdvancedAdverbConverter.java | 653 | Jun. 26, 2002 | 03:21 PM |
| AdvancedAdverbConverterWithMorphology.java | 6,489 | Jun. 26, 2002 | 03:21 PM |
| AdvancedAdverbConverterWrapper.java | 1,691 | Jun. 26, 2002 | 03:21 PM |
| aLocationTupleObjectContext.java | 3,081 | Mar. 18, 2002 | 08:46 PM |
| AnimationTransformation.java | 292 | Mar. 18, 2002 | 08:46 PM |
| AnimationTransformationChain.java | 792 | Mar. 18, 2002 | 08:46 PM |
| Any.java | 696 | Mar. 18, 2002 | 08:46 PM |
| AStarSearch.java | 6,810 | Mar. 18, 2002 | 08:46 PM |
| AttendingToTargetPercept.java | 931 | Mar. 18, 2002 | 08:46 PM |
| AttentionSelectorProgram.java | 19,664 | Mar. 28, 2002 | 07:04 PM |
| AutonomicVariableContext.java | 1,715 | Mar. 18, 2002 | 08:46 PM |
| AutonomicVariableWithRangeContext.java | 2,153 | Mar. 18, 2002 | 08:46 PM |
| BaseAdverbConverter.java | 7,269 | Jun. 26, 2002 | 03:21 PM |
| BaseBodyMetric.java | 6,618 | Mar. 18, 2002 | 08:46 PM |
| BaseMetric.java | 4,611 | Mar. 27, 2002 | 08:20 PM |
| BaseMotorSystem.java | 16,004 | Jul. 15, 2002 | 12:24 AM |
| BaseRewardableActionTuple.java | 1,417 | Oct. 09, 2002 | 04:30 PM |
| BearingAdverbConverter.java | 2,446 | Jun. 26, 2002 | 03:21 PM |
| BearingContext.java | 8,818 | Mar. 18, 2002 | 08:46 PM |
| BiAxialAdverbConverter.java | 1,676 | Jun. 26, 2002 | 03:21 PM |
| BlendedBodyPose.java | 10,869 | Jun. 26, 2002 | 03:38 PM |
| BlendingDelegate.java | 664 | Jun. 11, 2002 | 05:00 PM |
| BodyMetricI.java | 3,359 | Mar. 18, 2002 | 08:46 PM |
| BodyPose.java | 11,372 | Apr. 24, 2002 | 11:24 AM |
| BodyTimeMetric.java | 2,727 | Mar. 18, 2002 | 08:46 PM |
| BooleanDataRecord.java | 1,359 | Mar. 18, 2002 | 08:46 PM |
| BoundingBoxDataRecord.java | 2,534 | Mar. 18, 2002 | 08:46 PM |
| BoundingBoxPercept.java | 1,947 | Mar. 18, 2002 | 08:46 PM |
| BoundingBoxVisualDataRecord.java | 2,675 | Mar. 18, 2002 | 08:46 PM |
| CameraAction.java | 900 | Mar. 18, 2002 | 08:46 PM |
| CameraActionGroup.java | 1,741 | Mar. 18, 2002 | 08:46 PM |
| ClickerTimerTupleContext.java | 4,627 | Mar. 18, 2002 | 08:46 PM |
| ColorDataRecord.java | 657 | Mar. 18, 2002 | 08:46 PM |
| ConstantTupleContext.java | 632 | Mar. 18, 2002 | 08:46 PM |
| ConstrainedSquadRouteInterpolator.java | 3,740 | Mar. 18, 2002 | 08:46 PM |
| CreationTools.java | 37,475 | Oct. 16, 2002 | 01:54 PM |
| CreatureTrackingAction.java | 2,024 | Mar. 18, 2002 | 08:46 PM |
| CSEMTupleContext.java | 1,262 | Jun. 09, 2002 | 05:39 PM |
| DelayedProbabilisticTimerTupleContext.java | 3,751 | Mar. 28, 2002 | 07:04 PM |
| Description.java | 534 | Mar. 18, 2002 | 08:46 PM |
| DifferenceCreationTools.java | 2,906 | Apr. 24, 2002 | 11:24 AM |
| DifferencePose.java | 1,888 | Apr. 24, 2002 | 11:24 AM |
| DifferenceTools.java | 2,391 | Apr. 24, 2002 | 11:24 AM |
| DogEyeCameraAction.java | 5,140 | Mar. 18, 2002 | 08:46 PM |
| DoubleDataRecord.java | 1,283 | Mar. 18, 2002 | 08:46 PM |
| DoubleMemoryKeyDataRecord.java | 710 | Mar. 18, 2002 | 08:46 PM |
| DoubleProviderContext.java | 1,436 | Mar. 27, 2002 | 08:10 PM |
| DoubleTupleContext.java | 1,016 | Mar. 18, 2002 | 08:46 PM |
| EdgeDetectorTupleContext.java | 2,339 | Mar. 18, 2002 | 08:46 PM |
| EdgePercept.java | 7,162 | Mar. 28, 2002 | 07:04 PM |
| EyeCameraAction.java | 4,038 | Mar. 18, 2002 | 08:46 PM |
| FastConstrainedSquadRouteInterpolator.java | 4,142 | Mar. 18, 2002 | 08:46 PM |
| FastPoseRenderer.java | 1,551 | Mar. 18, 2002 | 08:46 PM |
| FastSquadRouteInterpolator.java | 20,228 | Jul. 15, 2002 | 10:51 AM |
| FireOnceTupleContext.java | 1,240 | Oct. 14, 2002 | 01:12 AM |
| FixedGoodThingBadThing.java | 2,340 | Oct. 09, 2002 | 04:30 PM |
| FixedRewardableValue.java | 751 | Jul. 14, 2002 | 12:31 AM |
| FloatModelPackage.java | 4,640 | Jul. 16, 2002 | 12:07 AM |
| FrameReciever.java | 1,714 | Mar. 27, 2002 | 08:10 PM |
| FrameSender.java | 1,600 | Mar. 27, 2002 | 08:10 PM |
| GeneralMemory.java | 4,861 | Jul. 03, 2002 | 03:09 PM |
| GlobalTools.java | 6,999 | Mar. 18, 2002 | 08:46 PM |
| GMMActionTuple.java | 2,681 | Aug. 06, 2002 | 02:00 PM |
| GMMClassifier.java | 5,272 | Jun. 24, 2002 | 01:38 PM |
| GMMClassifierPercept.java | 2,701 | Jun. 24, 2002 | 01:38 PM |
| GMMPercept.java | 6,679 | Jun. 30, 2002 | 12:20 AM |
| GoodThingBadThing.java | 28,828 | Oct. 16, 2002 | 12:38 PM |
| Graph.java | 15,502 | Oct. 14, 2002 | 09:20 AM |
| GraphMovementModel.java | 18,420 | Jul. 02, 2002 | 01:24 AM |
| GraphMovementModel2.java | 18,854 | Jul. 02, 2002 | 01:23 AM |
| GraphMovementModelPopulation.java | 1,629 | Mar. 18, 2002 | 08:46 PM |
| GraphNG.java | 14,427 | Apr. 24, 2002 | 11:24 AM |
| GraphNodeDataRecord.java | 930 | Mar. 18, 2002 | 08:46 PM |
| GraphNodePercept.java | 2,530 | Mar. 18, 2002 | 08:46 PM |
| GraphNodeRecognizer.java | 1,099 | Mar. 18, 2002 | 08:46 PM |
| GraphSOM.java | 10,359 | Apr. 24, 2002 | 11:24 AM |
| GravisEliminatorDataRecord.java | 6,412 | Dec. 08, 2003 | 09:58 PM |
| GrossMovementProgram.java | 7,039 | Mar. 18, 2002 | 08:46 PM |
| HeadingPercept.java | 1,115 | Mar. 18, 2002 | 08:46 PM |
| HierarchicalActionTuple.java | 2,558 | Apr. 24, 2002 | 11:45 PM |
| HybridTools.java | 3,114 | Mar. 18, 2002 | 08:46 PM |
| iAction.java | 362 | Mar. 18, 2002 | 08:46 PM |
| iActionGroup.java | 472 | Mar. 18, 2002 | 08:46 PM |
| iActionTuple.java | 2,859 | Mar. 18, 2002 | 08:46 PM |
| iActionTupleDelegate.java | 912 | May 31, 2002 | 03:39 PM |
| iClassifier.java | 916 | May 31, 2002 | 03:37 PM |
| iClassifierPercept.java | 543 | May 31, 2002 | 03:37 PM |
| iGMMPercept.java | 783 | Jun. 30, 2002 | 12:21 AM |
| iModelPercept.java | 811 | Jun. 24, 2002 | 01:23 PM |
| IndependentBodyMetric.java | 2,143 | Mar. 18, 2002 | 08:46 PM |
| InnovationalActionTuple.java | 24,899 | Oct. 16, 2002 | 12:38 PM |
| InnovationalPerceptTupleContext.java | 13,047 | Oct. 09, 2002 | 12:50 PM |
| InputWatchAction.java | 1,369 | Mar. 28, 2002 | 07:04 PM |
| Installer.java | 9,985 | Mar. 18, 2002 | 08:46 PM |
| iPercept.java | 609 | Mar. 18, 2002 | 08:46 PM |
| iPerceptDelegate.java | 447 | Jun. 24, 2002 | 01:23 PM |
| iRewardable.java | 213 | Mar. 18, 2002 | 08:46 PM |
| iStartleActionGroup.java | 409 | Mar. 18, 2002 | 08:46 PM |
| iTupleContext.java | 332 | Mar. 18, 2002 | 08:46 PM |
| iTupleObjectContext.java | 426 | Mar. 18, 2002 | 08:46 PM |
| iValueProvider.java | 174 | Mar. 18, 2002 | 08:46 PM |
| JoystickButtonPercept.java | 882 | Mar. 18, 2002 | 08:46 PM |
| JoystickDataRecord.java | 2,999 | May 31, 2002 | 03:34 PM |
| JoystickPercept.java | 685 | Mar. 18, 2002 | 08:46 PM |
| KeyboardDataRecord.java | 858 | Mar. 18, 2002 | 08:46 PM |
| LackOfUserInteractionTupleContext.java | 1,478 | Oct. 12, 2002 | 02:22 PM |
| LatchUntilActivateTupleContext.java | 322 | Mar. 18, 2002 | 08:46 PM |
| LatchUntilDeactivateTupleContext.java | 328 | Mar. 18, 2002 | 08:46 PM |
| LearningSetParamAction.java | 1,839 | Mar. 28, 2002 | 07:04 PM |
| LiveInput.java | 1,546 | Jun. 24, 2002 | 12:26 AM |
| LocatableDataRecord.java | 1,038 | Mar. 18, 2002 | 08:46 PM |
| LocationPercept.java | 4,457 | Mar. 18, 2002 | 08:46 PM |
| LowPassUntilActivateTupleContext.java | 2,342 | Mar. 18, 2002 | 08:46 PM |
| LowPassUntilDeactivateTupleContext.java | 2,347 | Mar. 18, 2002 | 08:46 PM |
| LureToFrameProgram.java | 12,449 | Oct. 16, 2002 | 01:55 PM |
| Memory.java | 857 | Jul. 03, 2002 | 03:09 PM |
| MemoryAction.java | 382 | Mar. 18, 2002 | 08:46 PM |
| MemoryContext.java | 781 | Mar. 18, 2002 | 08:46 PM |
| MemoryKeyDataRecord.java | 421 | Mar. 18, 2002 | 08:46 PM |
| MemoryStringContext.java | 982 | Mar. 18, 2002 | 08:46 PM |
| Metric.java | 458 | Mar. 18, 2002 | 08:46 PM |
| Metrics.java | 3,671 | Mar. 18, 2002 | 08:46 PM |
| MiniActionTuple.java | 15,132 | Mar. 28, 2002 | 07:04 PM |
| ModellingMemory.java | 2,073 | Jun. 30, 2002 | 12:44 AM |
| MotorActionCompletionTupleContext.java | 3,084 | Oct. 14, 2002 | 01:18 AM |
| MotorMemoryDataRecord.java | 732 | Jul. 03, 2002 | 03:09 PM |
| MotorProgram.java | 714 | Mar. 18, 2002 | 08:46 PM |
| MotorSequence.java | 2,639 | Mar. 18, 2002 | 08:46 PM |
| MotorSlotNamer.java | 819 | Mar. 18, 2002 | 08:46 PM |
| MotorSystem.java | 1,834 | Mar. 18, 2002 | 08:46 PM |
| MotorTrigger.java | 1,057 | Mar. 18, 2002 | 08:46 PM |
| MouseDataRecord.java | 2,635 | Jun. 23, 2002 | 06:05 PM |
| MousePercept.java | 889 | Mar. 18, 2002 | 08:46 PM |
| MovementModel.java | 433 | Jul. 02, 2002 | 01:28 AM |
| MovementTupleObjectContext.java | 3,218 | Mar. 28, 2002 | 07:04 PM |
| Mul.java | 1,016 | June. 09, 2002 | 05:38 PM |
| MulG.java | 866 | Mar. 18, 2002 | 08:46 PM |
| MultiContextWrapperContext.java | 2,955 | Oct. 14, 2002 | 02:25 AM |
| MultiPerceptTupleObjectContext.java | 3,349 | Mar. 28, 2002 | 07:04 PM |
| MultiPerceptWithProximityAndObjectOfAttentionTupleContext.java | 4,917 | Mar. 18, 2002 | 08:46 PM |
| MultiPerceptWithProximityTupleObjectContext.java | 4,767 | Mar. 28, 2002 | 07:04 PM |
| MultiplePoseRecognizerPercept.java | 1,398 | Mar. 18, 2002 | 08:46 PM |
| NDCLocatable.java | 141 | Mar. 18, 2002 | 08:46 PM |
| NoDelayPostAndDoJoystickWatchAction.java | 3,261 | Mar. 28, 2002 | 07:04 PM |
| NoopInnovationalPerceptTupleObjectContext.java | 1,037 | Mar. 18, 2002 | 08:46 PM |
| Not.java | 182 | Mar. 18, 2002 | 08:46 PM |
| NotAttendingToTargetPercept.java | 942 | Mar. 18, 2002 | 08:46 PM |
| NotTupleContext.java | 661 | Mar. 18, 2002 | 08:46 PM |
| ObjectDataRecord.java | 464 | Mar. 18, 2002 | 08:46 PM |
| ObjectOfAttentionTrackingAction.java | 2,265 | Mar. 28, 2002 | 07:04 PM |
| OneToThreeAdverbConverter.java | 1,488 | Jun. 26, 2002 | 03:21 PM |
| Percept.java | 10,453 | May 31, 2002 | 03:37 PM |
| PerceptDataRecord.java | 821 | Mar. 18, 2002 | 08:46 PM |
| PerceptionSystem.java | 8,279 | Oct. 11, 2002 | 11:36 PM |
| PerceptTupleContext.java | 2,870 | Mar. 28, 2002 | 07:04 PM |
| PerceptTupleObjectContext.java | 2,597 | Mar. 28, 2002 | 07:04 PM |
| PerceptWithProximityTupleContext.java | 3,396 | Mar. 28, 2002 | 07:04 PM |
| PerNodeRouteBlendWeightProvider.java | 588 | Jul. 10, 2002 | 10:37 PM |
| Persitance.java | 19,260 | Mar. 18, 2002 | 08:46 PM |
| PhysicalGrossMovementProgram.java | 8,863 | Mar. 18, 2002 | 08:46 PM |
| PhysicalSOM.java | 6,655 | Apr. 24, 2002 | 11:24 AM |
| PlaySoundFrame.java | 7,533 | Mar. 18, 2002 | 08:46 PM |
| Pose.java | 380 | Mar. 18, 2002 | 08:46 PM |
| PoseBlending.java | 3,692 | Mar. 27, 2002 | 08:10 PM |
| PoseDataRecord.java | 1,566 | Mar. 18, 2002 | 08:46 PM |
| PosegraphBoo.java | 434 | Mar. 18, 2002 | 08:46 PM |
| PosePercept.java | 609 | Mar. 18, 2002 | 08:46 PM |
| PoseRecognizerPercept.java | 1,007 | Mar. 18, 2002 | 08:46 PM |
| PoseRenderer.java | 378 | Mar. 18, 2002 | 08:46 PM |
| PostAndDoJoystickWatchAction.java | 4,165 | Mar. 28, 2002 | 07:04 PM |
| PostingAction.java | 875 | Mar. 18, 2002 | 08:46 PM |
| PostingInputToProprioceptionWatchAction.java | 1,457 | Mar. 28, 2002 | 07:04 PM |
| PostinglnputWatchAction.java | 1,684 | Mar. 18, 2002 | 08:46 PM |
| PostSoundAndDoInputWatchAction.java | 1,676 | Mar. 28, 2002 | 07:04 PM |
| ProbabilisticActionGroup.java | 30,199 | Oct. 11, 2002 | 01:36 AM |
| ProbabilisticTimerTupleContext.java | 1,356 | Mar. 18, 2002 | 08:46 PM |
| ProprioceptionDataRecord.java | 274 | Mar. 18, 2002 | 08:46 PM |
| ProprioceptionPercept.java | 807 | Mar. 18, 2002 | 08:46 PM |
| ProprioceptionStringModelPercept.java | 1,919 | Mar. 18, 2002 | 08:46 PM |
| ProprioceptionStringPercept.java | 891 | Mar. 18, 2002 | 08:46 PM |
| ProvidesDTW.java | 466 | Mar. 18, 2002 | 08:46 PM |
| ProvidesFFT.java | 190 | Mar. 18, 2002 | 08:46 PM |
| ProximityPercept.java | 910 | Mar. 18, 2002 | 08:46 PM |
| ProximityTupleObjectContext.java | 1,229 | Mar. 18, 2002 | 08:46 PM |
| RelevanceMetricGroup.java | 8,177 | Oct. 05, 2002 | 04:49 PM |
| RemapControllers.java | 1,524 | Mar. 18, 2002 | 08:46 PM |
| RetinalLocationPercept.java | 1,127 | Mar. 18, 2002 | 08:46 PM |
| RewardableActionTuple.java | 5,789 | Jul. 14, 2002 | 12:30AM |
| RewardableValue.java | 759 | Jul. 14, 2002 | 12:31AM |
| RotationTools.java | 4,025 | Mar. 18, 2002 | 08:46 PM |
| Route.java | 1,138 | Mar. 18, 2002 | 08:46 PM |
| RouteBlendWeightProvider.java | 324 | Mar. 18, 2002 | 08:46 PM |
| SafeTupleContext.java | 1,585 | Mar. 18, 2002 | 08:46 PM |
| Samplers.java | 51,322 | Oct. 16, 2002 | 01:54 PM |
| ScalarValuedActionTuple.java | 3,193 | Mar. 28, 2002 | 07:04 PM |
| ScaleAnimationData.java | 2,102 | Mar. 18, 2002 | 08:46 PM |
| SectorPercept.java | 2,003 | Mar. 18, 2002 | 08:46 PM |
| SetLayeredMotorParamsAction.java | 1,514 | Mar. 28, 2002 | 07:04 PM |
| SetMotorParamsAction.java | 2,544 | Mar. 28, 2002 | 07:04 PM |
| SetParamAction.java | 1,069 | Oct. 16, 2002 | 01:52 PM |
| SetParamTimedAction.java | 3,085 | Oct. 11, 2002 | 09:41 PM |
| ShapeDataRecord.java | 979 | Mar. 18, 2002 | 08:46 PM |
| ShapePercept.java | 2,707 | Mar. 18, 2002 | 08:46 PM |
| ShapePostingInputWatchAction.java | 1,358 | Mar. 28, 2002 | 07:04 PM |
| ShapeRecognizerPercept.java | 1,324 | Mar. 18, 2002 | 08:46 PM |
| ShapingInnovationalActionTuple.java | 6,816 | Oct. 09, 2002 | 10:43 AM |
| ShapingProbabilisticActionGroup.java | 3,831 | Jul. 11, 2002 | 08:01 PM |
| ShapingSetParamAction.java | 1,701 | Jul. 04, 2002 | 07:12 PM |
| ShepEyeCameraAction.java | 4,317 | Mar. 18, 2002 | 08:46 PM |
| SideEffectAction.java | 2,316 | Mar. 18, 2002 | 08:46 PM |
| SideEffectWithTriggerAction.java | 3,232 | Mar. 18, 2002 | 08:46 PM |
| SimpleStateProgram.java | 20,925 | Mar. 28, 2002 | 07:04 PM |
| SlowDCT.java | 1,622 | Mar. 18, 2002 | 08:46 PM |
| SoundDataRecord.java | 979 | Mar. 18, 2002 | 08:46 PM |
| SoundPercept.java | 2,897 | Mar. 28, 2002 | 07:04 PM |
| SoundRecognizerPercept.java | 1,065 | Mar. 18, 2002 | 08:46 PM |
| SpielbergCameraAction.java | 7,609 | Mar. 28, 2002 | 07:04 PM |
| SquadRouteInterpolator.java | 22,069 | Mar. 28, 2002 | 07:04 PM |
| StimulusInvTupleContext.java | 886 | Mar. 18, 2002 | 08:46 PM |
| StimulusTupleContext.java | 1,278 | Mar. 28, 2002 | 07:04 PM |
| StringDataRecord.java | 584 | Mar. 18, 2002 | 08:46 PM |
| StringMemoryKeyDataRecord.java | 713 | Mar. 18, 2002 | 08:46 PM |
| SubservientUtteranceClassifier.java | 1,493 | Mar. 18, 2002 | 08:46 PM |
| SuppressForTupleContext.java | 1,097 | Mar. 18, 2002 | 08:46 PM |
| TestAbstract.java | 4,493 | Mar. 27, 2002 | 08:20 PM |
| TestBlank.java | 4,657 | Mar. 27, 2002 | 08:20 PM |
| TimeFromActionTupleContext.java | 1,942 | Mar. 18, 2002 | 08:46 PM |
| TimeFromActivationTupieContext.java | 1,340 | Mar. 18, 2002 | 08:46 PM |
| TimeFromMotorActualTupleContext.java | 1,988 | Mar. 18, 2002 | 08:46 PM |
| TimerTupleContext.java | 1,276 | Mar. 18, 2002 | 08:46 PM |
| TimeWindowTupleContext.java | 1,622 | Mar. 18, 2002 | 08:46 PM |
| TopDownCameraAction.java | 5,563 | Mar. 18, 2002 | 08:46 PM |
| TriggerTimerTupleContext.java | 1,197 | Oct. 14, 2002 | 01:12 AM |
| TwoBySixBiAxialAdverbConverter.java | 2,163 | Jun. 26, 2002 | 03:21 PM |
| TwoContextWrapperContext.java | 2,638 | Mar. 18, 2002 | 08:46 PM |
| TwoToSixUndampedAdverbConverter.java | 2,164 | Jun. 26, 2002 | 03:21 PM |
| UnarbitratedActionGroup.java | 1,899 | Mar. 18, 2002 | 08:46 PM |
| UtteranceClassifier.java | 7,648 | Jun. 24, 2002 | 01:36 PM |
| UtteranceClassifierPercept.java | 3,757 | Jun. 24, 2002 | 01:36 PM |
| UtteranceDataRecord.java | 10,531 | Jun. 24, 2002 | 12:27 AM |
| UtteranceModelPercept.java | 11,250 | Jun. 24, 2002 | 01:36 PM |
| Vec2AdverbConverter.java | 1,583 | Jun. 26, 2002 | 03:21 PM |
| Vec2DataRecord.java | 1,282 | Mar. 18, 2002 | 08:46 PM |
| Vec3DataRecord.java | 2,115 | Mar. 18, 2002 | 08:46 PM |
| VecDataRecord.java | 986 | Mar. 18, 2002 | 08:46 PM |
| VisualDataRecord.java | 1,000 | Mar. 18, 2002 | 08:46 PM |
| WhateverPercept.java | 1,646 | Mar. 18, 2002 | 08:46 PM |
| WorkingMemoryStateProgram.java | 3,305 | Jun. 26, 2002 | 03:21 PM |
| WriteToMemoryAction.java | 583 | Mar. 18, 2002 | 08:46 PM |

### FIELD OF THE INVENTION

This invention relates to machine learning methods and apparatus.

### BACKGROUND OF THE INVENTION

The present invention is within the general category of reinforcement learning. Good introductions to this field may be found in: (1) KAELBLING, L. 1990, Learning in embedded systems. PhD thesis, Stanford University; (2) BALLARD, D. 1997, An Introduction to Natural Computation. MIT Press, Cambridge, MA.; (3) MITCHELL, K. 1997, Machine Learning. McGraw Hill, New York, N.Y.; and (4) SUTTON, R., AND BARTO, A. 1998, Reinforcement Learning: An Introduction. MIT Press, Cambridge Mass.

The incremental exploration of state-action space which is proposed below is similar to an approach originally suggested by DRESCHER, G. 1991. Made-Up Minds: A Constructivist Approach to Artificial Intelligence. MIT Press, Cambridge Mass. In contrast, our work is an integrated approach to state, action and state-action space discovery within the context of reinforcement learning and an articulation of heuristics and design principles that make learning practical for synthetic characters.

Our approach is also informed by a close study of animal training and what it seems to imply about how animals learn. For good introductions to animal learning, see (1) LORENZ, K., AND LEYAHUSEN, P. 1973, Motivation of Human and Animal Behavior: An Ethological View. Van Nostrand Rein-hold Co., New York, N.Y.; (2) LORENZ, K. 1981, The Foundations of Ethology. Springer-Verlag, New York, N.Y.; (3) SHETTLEWORTH, S. J. 1998, Cognition, Evolution and Behavior. Oxford University Press, New York, N.Y.; (4) GALLISTEL, C. R., AND GIBBON, J. 2000, Time, rate and conditioning. Psychological Review 107; (5) LINDSAY, S. 2000, Applied Dog Behavior and Training, Iowa State University Press, Ames, Iowa; and (6) COPPINGER, R., AND COPPINGER, L. 2001. Dogs: A Startling New Understanding of Canine Origin, Behavior, and Evolution. Scribner, New York, N.Y.

For an introduction to the field of animal training, see RAMIREZ, K. 1999, Animal Training: Successful Animal Management Through Positive Reinforcement, Shedd Aquarium, Chicago, Ill.; and for an introduction to the specific approach to training that we take as our inspiration, i.e., “clicker training”, see WILKES, G. 1995, Click and Treat Training Kit, Click and Treat Inc., Mesa, Ariz. Pryor 1999; and RAMIREZ, K. 1999, supra. Clicker training has been successfully adapted by researchers at SONY CSL to train their robotic dog AIBO as described by KAPLAN, F., OUDEYER, P.-Y., KUBINYI, E., AND MIKLOSI, A. 2001, Taming robots with clicker training: a solution for teaching complex behaviors, Proceedings of the 9th European workshop on learning robots, LNAI, Springer, M. Quoy, P. Gaussier, and J. L. Wyatt, Eds. See YOON, S., BURKE, R., AND BLUMBERG, B. 2000, Interactive training for synthetic characters, Proceedings of AAAI 2000. Motivation-driven learning for interactive synthetic characters, Proceedings of the Fourth International Conference on Autonomous Agents, for an early application of clicker training to training animated characters. The methods described here employ a computational model that not only uses animal training as a starting point, but places learning within the larger behavioral context.

In an effort to reduce the work required by animators, learning has been applied to the problem of generating motion primitives. (See VAN DE PANNE, M., AND FIUME., E. 1993, Sensor-actuator networks, Proceedings of SIGGRAPH 1993, ACM Press/ACM SIGGRAPH, Computer Graphics Proceedings, Annual Conference Series, ACM.; VAN DE PANNE, M., KIM, R., AND FIUME., E. 1994, Synthesizing parameterized motions, 5th Eurographics Workshop on Simulation and Animation.; GRZESZCZUK, R., AND TERZOPOULOS, D. 1995, Automated learning of muscle-actuated locomotion through control abstraction, Proceedings of SIGGRAPH 1995, ACM Press /ACM SIGGRAPH, Computer Graphics Proceedings, Annual Conference Series, ACM.; GRZESZCZUK, R., TERZOPOULOS, D., AND HINTON, G. 1998, Neuroanimator: Fast neural network emulation and control of physics-based models, Proceedings of SIGGRAPH 1998, ACM Press/ACM SIGGRAPH, Computer Graphics Proceedings, Annual Conference Series, ACM; HODGINS, J., AND POLLARD, N. 1997, Adapting simulated behaviors for new characters, Proceedings of SIGGRAPH 1997, ACM Press/ACM SIGGRAPH, Computer Graphics Proceedings, Annual Conference Series, ACM; GLEICHER, M. 1998, Retargetting motion to new characters, Proceedings of SIGGRAPH 1998, ACM Press/ACM SIG-GRAPH, Computer Graphics Proceedings, Annual Conference Series, ACM; GOULD, J., AND GOULD, C. 1999, The Animal Mind. W. H. Freeman, New York, N.Y. and, most recently, FALOUTSOS, P., VAN DE PANNE, M., AND TERZOPOLOUS, D. 2001, Composible controllers for physics-based character animation, Proceedings of SIGGRAPH 2001, ACM Press/ACM SIGGRAPH, Computer Graphics Proceedings, Annual Conference Series, ACM, have shown how a statistical learning technique (SVM) can be used to learn the “pre-conditions” from which a given “specialist controller” can succeed at its task, thus allowing such controllers to be combined into a general purpose motor system for physically based animated characters.

The approaches to motor learning described above focus on learning “how to move” subject to some criteria such as energy minimization, whereas the motor learning that is described here focuses on learning the “value with respect to a motivational goal of moving in a certain way.” As such, our approach represents a layer above many of these prior approaches. Finally we note that our emphasis is on learning as an online capability to enhance interaction with a human participant rather than as a design tool.

A number of noteworthy architectures for control of animated autonomous characters have been proposed, including: REYNOLDS, C. 1987, Flocks, herds and schools: A distributed behavioral model, Proceedings of SIGGRAPH 1987, ACM Press/ACM SIGGRAPH, Computer Graphics Proceedings, Annual Conference Series, ACM.; TU, X., AND TERZOPOULOS, D. 1994, Artificial fishes: Physics, locomotion, perception, behavior, Proceedings of SIGGRAPH 1994, ACM Press/ACM SIGGRAPH, Computer Graphics Proceedings, Annual Conference Series, ACM.; BLUMBERG, B., AND GAYLEAN, T. 1995, Multi-level direction of autonomous creatures for real-time virtual environments, Proceedings of SIGGRAPH 1995, ACM Press/ACM SIG-GRAPH, Computer Graphics Proceedings, Annual Conference Series, ACM; PERLIN, K., AND GOLDBERG, A. 1996, Improv: A system for scripting interactive actors in virtual worlds, Proceedings of SIGGRAPH 1996, ACM Press I ACM SIGGRAPH, Computer Graphics Proceedings, Annual Conference Series, ACM; FUNGE, J., TU, X., AND TERZOPOLOUS, D. 1999, Cognitive modeling: Knowledge, reasoning and planning for intelligent characters. In Proceedings of SIGGRAPH 1999, ACM Press/ACM SIGGRAPH, Computer Graphics Proceedings, Annual Conference Series, ACM; and BURKE, R., ISLA, D., DOWNIE, M., IVANOV, Y., AND BLUMBERG, B. 2001, Creature smarts: The art and architecture of a virtual brain, Proceedings of the Computer Game Developers Conference. While producing impressive results, most of these systems have not incorporated behavioral learning and thus cannot modify the pre-specified behavior on the basis of experience. The system described below integrates learning into a general-purpose behavior architecture.

Higher-level behavioral learning has only begun to be explored in computer graphics. (For examples, see YOON, S., BURKE, R., AND BLUMBERG, B. 2000, Interactive training for synthetic characters, Proceedings of AAAI 2000; BURKE, R., ISLA, D., DOWNIE, M., IVANOV, Y., AND BLUMBERG, B. 2001, Creature smarts: The art and architecture of a virtual brain, Proceedings of the Computer Game Developers Conference; and TOMLINSON, B., AND BLUMBERG, B. 2002, Alphawolf: Social learning, emotion and development in autonomous virtual agents, First GSFC/JPL Workshop on Radical Agent Concepts. Several of the current generations of digital pets such as Dogz (RESNER, B., STERN, A., AND FRANK, A. 1997, The truth about catz and dogz. The Computer Games Developer Conference, 1997); Creatures (GRAND, S., CLIFF, D., AND MALHOTRA, A. 1996, Creatures: Artificial life autonomous agents for home entertainment, Proceedings of the Autonomous Agents '97 Conference), and AIBO also incorporate simple learning. This is done particularly well in Dogz, to the point that many people are convinced that more learning is going on than is actually the case. Factors contributing to this assumption include: immediate emotional responses by the creature to good or bad consequences, intuitive means for delivering reward or punishment, and an immediate and noticeable change in behavior in response. The popular video game Black and White (EVANS, R. 2002, Varieties of learning, AI Game Programming Wisdom, E. Rabin, Ed. Charles River Media, Hingham Mass.) centrally features a character that learns from a person's actions. The present invention provides insights into how state and action space discovery can be integrated into the learning process.

### SUMMARY OF THE INVENTION

The preferred embodiment of the present invention consists of several interdependent algorithms that work together to provide a fast and practical approach to real time perceptual, behavioral and motor learning for autonomous systems, including but not limited to, autonomous animated characters. These algorithms are especially useful in domains in which there aren't enough examples to utilize more traditional statistical learning approaches. Included in these algorithms is explicit support for real time training by “unskilled” trainers whose visibility into the internal state of the system is limited to the system's observable behavior.

The dominant trend in machine learning has been to eschew built-in structure or a priori knowledge of the environment and to discover structure that is in the data or the world through exhaustive search and/or sophisticated statistical learning techniques. Most prior approaches typically require hundreds or thousands of examples in order to learn successfully. As a result, such techniques are inappropriate for the type of real-time interactive learning that is required of autonomous systems that interact with, and learn from humans. By contrast, the present invention explicitly incorporates structure and a priori knowledge of how the world works and how human trainers train, and as a result the system can learn the kinds of things an animal such as a dog learns in a training setting on the basis very few examples (less than a dozen typically.)

A key insight has been to approach the problem of implementing a fast and practical technique for real time learning from the perspective of dog training. This is a valuable point of departure for several reasons:

1. Dogs perform the equivalent of state, action and state-action space discovery several orders of magnitude more quickly than traditional machine learning techniques. This suggests that they may make use of heuristics that drastically reduce the potential search space and are able to construct adequate perceptual models on the basis of relatively few examples. Similarly, the algorithm preferably incorporates heuristics that reduce the search space and focus resources on promising areas.

2. Animal training is best viewed as a coupled system in which the trainer and the animal cooperate so as to guide the animal's exploration of its state, action, and state-action spaces. Dogs seem to be able to draw the “right” lesson from the trainer's actions suggesting that even simple inferences as to the trainer's intent on the part of the dog may be sufficient to radically simply the learning and training process.

3. Animal trainers have developed fast and efficient techniques to train animals based on how they seem to learn The specific techniques used by animal trainers including “clicker training”, “luring” and “shaping” are powerful techniques for guiding the state, action, and state-action space discovery processes even when the trainer's visibility into the internal state of the system is, in fact, limited to what can be inferred from the system's observed behavior.

As illustrated by the preferred embodiment to be described, our computational model addresses the problem of learning in large state and action spaces in several important ways:

First, we take advantage of predictable regularities in the world. For example, our creatures bias their choice of action toward those actions that have been successful at receiving reward in the past. Similarly, they limit their attention to stimuli or cues that occur in a temporal window around an action's onset in order to identify reliable contexts in which to perform the action. Through variations in how the action is performed and by attending to correlations between the action's reliability in producing reward and the state of contemporaneous stimuli, they are performing a local search in a potentially valuable neighborhood.

Secondly, we take maximum advantage of any supervisory signals, either explicit or implicit, that the world offers. Biasing the choice of behavior based on consequences is an example of making use of explicit supervisory signals (such as getting a treat). The consequences of the action, however, can also be used as an implicit (secondary) supervisory signal for guiding the exploration of the character's state and action spaces. That is, we use the context of rewarded actions to guide the creation of model-based classifiers for detecting the presence of perceptual cues that seem correlated with the increased reliability of the action in producing positive feedback. The idea is simple: if an action is rewarded we look to see if a potential cue was detected during the action's attention window. If so, we assume that it is a good example of the cue and that example is incorporated into a perceptual model for that the cue. If the action is not rewarded, then we assume that even if the cue was present during the attention window, it was not a “good” example of the cue and any perceptual model of the cue that may exist is left unchanged. In other words, we build models of important sensory cues “on demand”, using rewarded actions as the context for identifying important sensory cues and for guiding the perceptual model of the cue. The practical effect is that fewer models are built and those that are built tend to be more relevant and robust.

Our computational model supports standard animal training techniques such as shaping, clicker training and luring. These techniques provide a fast and efficient means to guide the system's learning. An important contribution of the work is to elucidate what is required on the part of the learning system in order to support these training techniques.

Since the trainer's visibility into the character's internal state is limited to its observable behavior, its observable behavior must be an accurate and immediate reflection of what it has learned. Thus, on the simplest level, the character must be sensitive to the immediate consequences of its actions, attend to changes in stimuli that occur right before and during its performance of an action, and change its behavior in response.

It is critical to ensure that the rules for credit assignment are consistent with the observed behavior. Specifically, we introduce the mechanism of “delegated credit assignment” in which the entity that normally would receive credit “delegates” the credit to the entity that is most consistent with the trainer's likely intent. Here are three examples of its use:

1. Credit received in the interval between when the action system decides to switch behaviors, and when the observable behavior actually changes, is assigned to the action responsible for the observed behavior at the time the reward occurs, even if it no longer active. This is referred to as deferred credit assignment and is an example of modifying the credit assignment process so as to match the trainer's probable intent.

2. Credit received during luring is assigned to the action, if it exists, that is most associated with lured pattern of movement. For example, if the character already knows how to “lie-down”, and they are lured into lying down and subsequently rewarded, the trainer's natural assumption (and the one that the system needs to support) is that they are rewarding the action of lying down.

3. Credit may be assigned to a related state-action pair rather than the active state-action pair, if it seems more consistent to do so given the inferred intent of the trainer. For example, assume a character has two forms of an action: one of which is performed spontaneously, and one of which is performed in response to a previously learned verbal cue. If the character begins to perform the action in the absence of the cue, but subsequently detects the presence of the cue shortly after the onset of the action, then the more specific form of the action (i.e., the one associated with the cue) is the one that gets the credit, even though the more general form of the action was the one that was actually active.

Our experience has been that incorporating even simple inferences of the trainer's intent into the learning algorithm are essential components of a system that can be trained based on its observable behavior.

The more general problem addressed is the problem of building an adaptive system that can be subsequently trained in real time based on its observable behavior, which may prove to be a core technology for a new approach to building systems in which the system is “trained” rather than programmed to meet the needs of a specific application. This may be especially important in domains in which it is hard to specify the solution a priori.

It should also be noted that the learning mechanism implemented in the system does not require the presence of an explicit trainer. The only requirement is the presence of a feedback signal.

These and other features and advantages of the present invention may be better understood by considering the following detailed description.

### BRIEF DESCRIPTION OF THE DRAWINGS

In the detailed description which follows, frequent reference will be made to the attached drawings, in which:

FIG. 1 illustrates a computer output screen display and gamepad used to implement an embodiment of the invention;

FIG. 2 illustrates the hierarchical state space which is searched to select an appropriate action by the synthetic character;

FIG. 3 illustrates how searching is executed;

FIGS. 4 and 5 are hierarchical state diagrams illustrating state-action space discovery; and

FIG. 6 depicts a screen display used to show the animated character's behavior and a visual display of action tuples.

### DETAILED DESCRIPTION

Introduction

We believe that interactive synthetic characters must learn from experience if they are to be compelling over extended periods of time. Furthermore, they must adapt in ways that are immediately understandable, important and ultimately meaningful to the people interacting with them. Nature provides an excellent example of systems that do just this: pets such as dogs.

Remarkably, dogs do this with minimal insight into our behavior, and little understanding of words and gestures beyond their use as cues. In addition, dogs are only able to learn causality if the events, actions and consequences are proximate in space and time, and as long as the consequences are motivationally significant. Nonetheless, the learning dogs do allow them to behave commonsensically and ultimately exploit the highly adaptive niche of “man's best friend.” Our belief is that by embedding the kind of learning of which dogs are capable into synthetic characters, we can provide them with an equally robust mechanism for adapting in meaningful ways to the people with whom they are interacting.

In this specification, we describe a practical approach to real-time learning for synthetic characters that allows them to learn the kinds of things that dogs seem to learn so easily. We ground our work in the traditional techniques of reinforcement learning, in which a creature learns to maximize reward in the absence of a teacher. Additionally, our approach is informed by insights from animal training, where a teacher is available. Animals and their trainers act as a coupled system to guide the animal's exploration of its state, action, and state-action spaces, as described below. Therefore, we can simplify the learning task for autonomous animated characters by (a) enabling them to take advantage of predictable regularities in their world, (b) allowing them to make maximal use of any supervisory signals, either explicit or implicit, that the world offers, and (c) making them easy to train by humans.

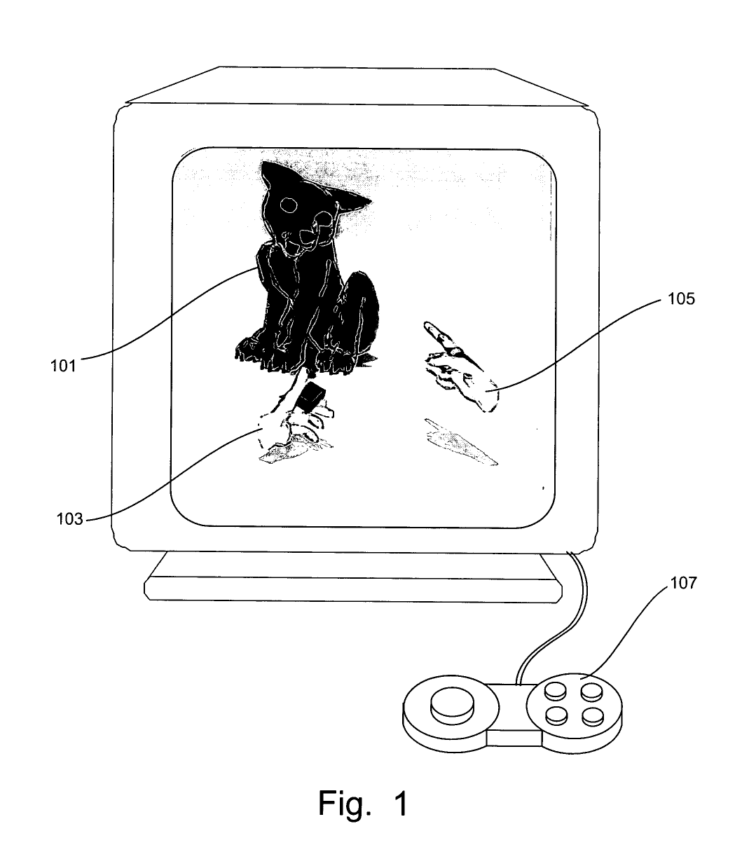

The synthetic character is exemplified by “Dobie,” an autonomous animated pup seen on the screen display at 101 in FIG. 1, that can be trained using clicker training. The trainer's interface is a microphone (not shown) and pair of virtual hands seen at 103 and 105 controlled by a gamepad 107. The left hand 103 holds a clicker that makes a sound when pressed. The right hand 105 serves as a target for luring, and can also give extra reward by scratching the dog's head. Using this system, we implemented the autonomous animated dog Dobie seen in FIG. 1 that can be trained with a technique used to train real dogs. The synthetic dog thus mimics some of a real dog's ability to learn including: (a) the best action to perform in a given context; (2) what form of a given action is most reliable in producing reward; (3) the relative reliability of its actions in producing a reward and altering its choice of action accordingly; (4) to recognize new and valuable contexts such as acoustic patterns; and (5) to synthesize new actions by being “lured” into novel configurations or trajectories by the trainer.

In order to accomplish these learning tasks, the system must address the three important problems of state, action and state-action space discovery. A key feature of the invention resides in the integrated approach used to guide and simplify the individual processes.

We emphasize that our behavioral architecture is one in which learning can occur, rather than an architecture that solely performs learning. As we will see, learning has important implications for many aspects of a general behavior architecture, from the design of the perceptual mechanism to the design of the motor system. Conversely, careful attention to the design of these components can dramatically facilitate the learning process. Hence, an important goal is to highlight some of these key design considerations and to provide useful insights apart from the specifics of the approach that we have taken.

In the background section above, related work was reviewed to place our work in perspective. We now turn to a discussion of reinforcement learning. We introduce the core concepts and terminology, discuss why a naive application of reinforcement learning to synthetic characters is problematic, and finally draw on insights from animal training on how animals conceptually address the same issues. We then describe our approach, reviewing our key representations and processes for state, action and state-action space discovery. We describe our experience with Dobie, our virtual pup, and discuss limitations of our approach. We conclude with a summary of what we see as important aspects of this work.

Background on Learning and Training

The approach taken in our work is best understood as a variant of a popular machine learning technique known as reinforcement learning. In this section we begin by introducing the key ideas and terminology. We then look at the problem from the perspective of animal training and highlight the key ideas from animal training that can help make reinforcement learning practical for interactive synthetic characters.

Introduction to Reinforcement Learning

Reinforcement learning (RL) is often used by autonomous systems that must learn from experience. In reinforcement learning, the world in which the creature lives is assumed to be in one of a set of perceivable states. The goal of reinforcement learning is to learn an optimal sequence of actions that will take the creature from an arbitrary state to a goal state in which it receives a reward. The main approach taken by reinforcement learning is to probabilistically explore states, actions and their outcomes to learn how to act in any given situation. Before we describe how this is done, we need to define state, action and reward a bit more formally.

State refers to a specific, hopefully useful, configuration of the world as sensed by the creature's entire sensory system. As such, state can be thought of as a label that is assigned to a sensed configuration. The space of all represented configurations of the world is known as the state space.

Performing an action is how a creature can affect the state of its world. Typically, the creature is assumed to have a finite set of actions, from which it can perform exactly one at any given instant, e.g., walk or eat. The set of all possible actions is referred to as the action space.

A state-action pair, denoted as <S/A>, is a relationship between a state S and an action A. It is typically accompanied by some numeric value, e.g., future expected reward, that indicates how much benefit there is in taking the action A when the creature senses state S. Based on this relationship a policy is built, which represents a probability with which the creature selects an action given a specific state.

The creature receives reinforcement (or reward) when it reaches a state in which it can satisfy a goal. For example, if a dog sits and gets a treat for doing so, the reward or reinforcement is the resulting decrease in hunger or pleasure in eating the treat.

Credit assignment is the process of updating the associated value of a state-action pair to reflect its apparent utility for ultimately receiving reward.

While there are a number of variants of reinforcement learning, Q-Learning is a simple and popular representative that can be used to illustrate some key concepts. In Q-Learning, introduced by WATKINS, C. J., AND DAYAN, P. 1992, Q-learning. Machine Learning 8, the state-action space is discretized if necessary and stored in a lookup table. In the table, each row represents a state, and each column represents an action. An entry in the table represents the “utility”, or Q-Value, of a given state-actionpair with respect to getting a reward. Watkins showed that the optimal value for each state-actionpair could be learned by incrementally (and exhaustively) exploring the space of state-actionpairs and by using a local update rule to reflect the consequences of taking a given action in a given state with respect to achieving the goal state. See SUTTON, R. 1991. Reinforcement learning architectures for animates, The First International Conference on Simulation of Adaptive Behavior, MIT Press, Paris, Fr.

It is important to note that techniques such as Q-Learning that focus on learning an optimal sequence of actions to get to a goal state solve a much harder problem than either animals solve or that we need to solve for synthetic characters. As we will see, animals are biased to learn proximate causality. Even in the case of sequences, the noted ethnologist Leyahusen suggests that the individual actions may be largely self-reinforcing, rather than being reinforced via back propagation. See LORENZ, K., AND LEYAHUSEN, P. 1973, Motivation of Human and Animal Behavior: An Ethological View. Van Nostrand Rein-hold Co., New York, N.Y. In addition, Nature places a premium on learning adequate solutions quickly.

Reinforcement learning is an example of an unsupervised learning technique in that the only supervisory signal is the reward received when it achieves a goal. On the other hand, it is clear that a trainer could significantly expedite exploration of the respective spaces by guiding the search. In the following section we discuss how trainers and their animals cooperate to simplify the learning task.

The Perspective of Animal Training

We next describe a popular and easy technique for animal training called “clicker training” and what it seems to imply about how animals learn.

Clicker training unfolds in three basic steps. The first step is to create an association between the sound of a toy clicker and a food reward. A dog conditioned to the clicker will expectantly look for a treat upon hearing the click sound. Once the association between clicks and treats is made, trainers use the click sound to “mark” behaviors that they wish to encourage. By clicking when the dog performs a desired behavior, and subsequently treating, the dog begins to perform the behavior more frequently.

Animals appear to make an important simplifying assumption: an action or stimulus that immediately precedes a motivationally significant consequence is “as good as causal.” Hence, clicker training is a particularly effective training technique because it makes it easy to provide immediate feedback. Indeed, the sound of the clicker marks the exact behavior that leads to the subsequent treat, as well as signaling that the action is complete. In addition, it acts as a bridge between when the dog earned the reward and when it actually receives it.

Since clicker training relies on the dog to produce some approximation of a desired behavior before it can be rewarded (and producing a high level of reinforcement keeps the dog interested in the process), trainers utilize a variety of techniques to encourage the dog to perform behaviors they might otherwise perform infrequently, or not at all. A useful and popular technique is to train the dog to touch an object such as the trainer's hand or a “target stick”. By subsequently manipulating the position of the target, the trainer can, in effect, lure the dog through a trajectory or into a pose as it follows its nose. For example, by moving the target over the dog's head, a dog may be lured into sitting down. If lured and rewarded repeatedly, the dog will begin to produce the action (e.g., sit) with-out being lured. This suggests that the animal is associating reward with its resulting body configuration or trajectory, and not for the action of simply following its nose.

The dog is unlikely to perform the desired final form of the behavior immediately, especially if it is an unusual behavior, e.g., “dancing on the two rear feet”. As a result, the trainer will often guide the dog toward the desired behavior by rewarding ever-closer approximations in a process known as shaping.

The third and final step in clicker training is to add a discriminative stimulus such as a gesture or vocal cue. Trainers typically introduce the cue by presenting it as the animal is just beginning to perform the action, and then subsequently rewarding the action. Significantly, the animal has already decided what to do before the trainer issues a cue but is still able to learn to associate the action (and its subsequent reward) with a cue occurring in a temporal window proximate to the action onset. Note, unlike other training techniques, clicker trainers teach the action first, and then the cue. The superiority of this decomposition suggests that animals make associations more easily if they already “know” a particular action is valuable.

Making Learning Practical for Synthetic Characters

While reinforcement learning provides a theoretically sound basis for building systems that learn, there are a number of issues that make it problematic in the context of autonomous animated creatures. Borrowing ideas from animal training, however, we can address these problems in a way that makes real-time learning practical for synthetic characters.

Enable them to take advantage of predictable regularities in their world:

We saw that dogs use predictable regularities of how the world works to simplify the learning task. For example, they bias their choice of action toward those actions that have been successful at receiving reward in the past. Similarly, they limit their attention to stimuli or cues that occur in a temporal window around an action's onset in order to identify reliable contexts in which to perform the action. Through variations in how the action is performed and by attending to correlations between the action's reliability in producing reward and the state of contemporaneous stimuli, they are performing a local search in a potentially valuable neighborhood.

This model of causality, while very simple, is nonetheless sufficient to capture many aspects of how the world works. Perhaps as important for synthetic characters, learning proximate causality is exactly the kind of learning that is most apparent and easiest to understand for an observer. A final insight is that the state and action spaces often contain a natural hierarchical organization that facilitates the search process.

Allow them to make maximal use of any supervisory signals, either explicit or implicit, that the world offers:

Biasing the choice of behavior based on consequences is an example of making use of explicit supervisory signals (such as getting a treat). The consequences of the action can also be used as an implicit (secondary) supervisory signal for guiding the exploration of the character's state and action spaces. This guidance is significant because synthetic characters, by their very nature, have state and action spaces that are both continuous and far too big to permit an exhaustive search, even if discretized. For example, the a priori state space for a character that must learn to respond to arbitrary verbal or gestural cues, will be intractably huge since it will include the entire set of possible acoustic and gestural patterns. Similarly, in the case of an expressive character for whom the style of the action is as important as the action itself, the action space will be the space of all possible motions. Ironically though, most of the volume of these respective spaces is irrelevant from the character's standpoint of getting reward.

Our observation from animal training is that animals seem to solve this problem by building models of important sensory cues “on demand”, using rewarded actions as the context for identifying important sensory cues and for guiding the perceptual model of the cue. For example, a good example of the acoustic pattern “sit” is the one that occurs just before or during a sit action that results in reward. This point suggests a computational strategy-discover, based on experience, those patterns (in the case of state space) or motions (in the case of action space) that do seem to matter and add them dynamically to their respective spaces. These processes are known as state space discovery and action space discovery respectively. While there are established techniques for performing state-space discovery (see, for example, IVANOV, Y., State Discovery for Autonomous Creatures, PhD thesis, 2001, The Media Lab, MIT), they often require a lot of data. A key insight is that these processes can be guided by using the context of a rewarded action to facilitate the classification process. Indeed, by choosing the right representation, state and action space discovery can be done using exactly the same mechanism.

Make them easy to train:

For training to be a compelling experience for the human participant, the character needs to be easy to train using observable behavior, without the trainer having any visibility into the character's internal state.

On the simplest level, the character must be sensitive to the immediate consequences of its actions, attend to changes in stimuli that occur right before and during its performance of an action, and its observable behavior must change quickly in response. The ability to be trained via luring is especially important since otherwise the trainer has to wait for the animal to randomly choose the action, which could take forever.

Our discussion of animal training suggests that animals perform the equivalent of credit assignment in a way that makes it easier to train them than it might be otherwise. In the case of luring, they generalize from being rewarded for “following their nose” to being rewarded for their resulting configuration or trajectory. In the language of reinforcement learning, it is as if during credit assignment the “follow your nose” state-action pair lets another state-action pair get the credit, namely the one associated with the configuration or trajectory. Similarly, when associating a cue with an action, animals act as if they form and assign credit to new state-action pairs based on evidence acquired while performing an existing but related state-action pair (i.e., one that shares the same action). The computational implication of luring and cue association is that by allowing the state-action pair that would normally get credit to delegate its credit to another pair, the training process can be facilitated.

System Description

The accompanying Appendix on CD-ROM contains Java language source language listings that provide implementation details and the exact form of an illustrative embodiment of the invention. In this implementation, a synthetic character (a pup named “Dobie”) can be trained using techniques borrowed from dog training (i.e., clicker training, shaping, luring, etc.) to perform specific actions (e.g., lie-down sit, beg, etc) in response to arbitrary acoustic cues chosen by the trainer. The trainer can also train Dobie to perform novel actions (e.g. a FIG. 8 movement), as well as actions that it might not otherwise perform (e.g., roll-over.) In addition, the trainer is able to guide the dog's performance of an action to chose the best form of the action. The trainer may also train the dog not to perform certain actions as well. All of this is done using the dog's observable behavior as the sole means of inferring its internal state. The following section provides a high level description of the algorithms and heuristics that make this possible,

Key Representations

State Many state spaces have a natural hierarchical organization, e.g., the space of acoustic patterns, the space of utterances, and individual utterances such as “sit”, “down” and “roll over”. By incorporating a similar hierarchical representation of state space into our system, we can “notice” that a given action is more reliable when a whole class of states is active. This information provides evidence that further exploration and refinement within a class of states might be fruitful for increasing reliability of reward.

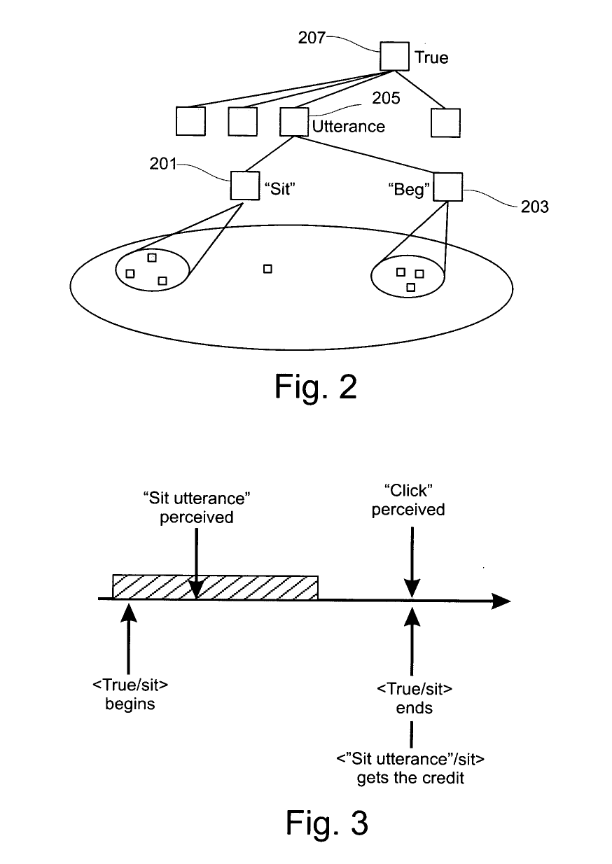

In our work the state space is represented by a percept tree as seen in FIG. 2. The percept tree maintains a hierarchical representation of the sensory input where leaf nodes represent the highest degree of specialization and the root node matches any sensory input. The structure of the tree is sequentially discovered and refined with time as indicated by its utility with respect to getting reward. As illustrated in FIG. 2, we use a hierarchical mechanism called a percept tree to extract state information from the world. Each node in the tree is called a percept, with more specific percepts nearer to the leaves. Percepts are atomic perception units, with arbitrarily complex logic, whose job it is to recognize and extract features from raw sensory data. For example, one percept seen at 201 may recognize the presence of the utterance “sit” in an auditory stream, and another might recognize the performance of a particular motor trajectory. Similarly, an “utterance” percept at 205 might recognize the presence of “utterances” in an auditory field, and its children might recognize the presence of specific utterances such as “sit”, “down”, “roll-over”, etc. The root of the tree seen at 207 is the most general percept, which we call “True” since it is always active.

Percepts are model-based recognizers, meaning that on each simulation cycle they compare raw sensory data to an internal model and become active if they match within some threshold. If a percept is active, the sensory data is passed recursively to the percept's children for more specific classification. If not, all its children can be pruned from the update cycle. This culling is important since percept models can vary in complexity. For symbolic data, the model is trivial: it is a string and the matching criterion is simple string equality. In the case of an utterance percept, however, the model may be a collection of vectors of cepstral coefficients (see RABINER, L., AND JUANG, B.-H., Fundamentals of Speech Recognition. Prentice Hall, Englewood Cliffs, N.J., 1993) that represent the mean of a set of previously learned examples (see IVANOV, Y. 2001. State Discovery for Autonomous Creatures. PhD thesis, The Media Lab, MIT.) and the comparison between sensory data and the model is more complex (section 4.2.3). Motion percepts use a model that represents a path through the space of possible motions. Also associated with each percept is a short-term memory mechanism that keeps track of its activation history over some period of time.

In the language of RL, a percept represents a subset of the entire state space. That is, it looks for a specific feature in the state space. In RL, state refers to the entire sensed configuration of the world; a percept is focused on only one aspect of that configuration. As we will see, percept decomposition of state allows for a heuristic search through potentially intractable state and state-action spaces. The downside is that it makes learning conjunctions of features harder.

It is important to note that the percept tree is a dynamic structure that is modified as a result of state space discovery as described below.

Action

Actions refer to identifiable patterns of motion through time. They are often conceptualized and implemented as discrete verbs, perhaps parameterized with associated adverbs (see ROSE, C., COHEN, M., AND BODENHEIMER, B., Verbs and adverbs: Multidimensional motion interpolation. IEEE Computer Graphics And Applications 18, 5, 1999). While this approach has the desirable property that other parts of the system can treat the action as a label, the representation is not amenable to the type of action space discovery needed to support luring. In contrast, if we consider a creature as having a pose space that contains all of its possible body configurations, then an action can be thought of as a specific path through pose space. Just as a percept is a label for a class of observations, an action can be thought of as a label associated with a path or class of paths in pose space. For the purposes of learning, the analogy to state learning is complete if one assumes the existence of a distance metric that evaluates the similarity of two paths. This is the fundamental representation of action used by our system.

Each creature in our system has a motor system with a representation of the creature's pose space encoded in a structure called a pose-graph. The nodes in the pose-graph represent annotated configurations that are generated originally from source animation material. A node includes a complete set of joint angles and velocities as well as a number of annotations including time and source-labeling (i.e., what animation it came from and at what point within the animation), connectivity information (e.g., the preceding and following poses in the source animation), and over time, a distribution of the likelihood of being in the current pose as a result of all known actions. For example, a pose associated with a sitting configuration might be the result of sitting or shaking a paw but is unlikely to be associated with being told to jump.

The nodes of this graph are connected together in tangled directed, weighted graphs. By associating a distance metric between poses, paths taking the body from pose to pose can be efficiently found and animations can be reformed in real-time by interpolating through nodes together again as needed. Details regarding the actual metric may be found in DOWNIE, M. behavior, animation, music: the music and movement of synthetic characters. Master's thesis, The Media Lab, MIT. 2000, but essentially it captures the intuition that transitioning between similar joint configurations should be preferred over widely differing joint configurations, and that transitions that require less acceleration should be favored over those that require more. Because the pose-graph is derived from “correct” examples, it implicitly captures, to some approximation, many of the biological and physical constraints of how the creature moves-at the very least we are always interpolating within the convex hull of these “correct” examples. In addition to the pose-graph, the motor system contains motor programs that are capable of generating paths through pose-graphs in response to requests from actions. These programs may be quite simple (essentially no more than playing out a particular animation) or more complex (for example, luring towards an object).

One branch of the percept tree is devoted to motor percepts that recognize paths taken by the motor system through pose space. That is, a given motor percept has a model of a path and the capability to compare a novel path to this model. As we will see in section 4.2.4 this allows us to treat action space discovery using almost the identical mechanism as used in state space discovery.

The key points about action are that (a) our underlying representation of action is that of a path through a space of body configurations, (b) we can calculate a distance metric between paths that reflects the similarity between two paths, (c) associated with each path is a “label” and (d) the label is used to specify which path through pose space the motor system should follow at any given point in time.

State-Action

The representation of a particular state-action pair in our system is called an action tuple. An action tuple is composed of five elements that specify: what to do, when, to what, for how long, and why. However, one can think of an action tuple as an augmented state-action pair in which the state information is provided by an associated percept (when), and the action (what) is the label for a given path through pose space. Action tuples are organized into groups and compete probabilistically for activation based on their value and applicability (i.e., if their associated percept is active). In the discussion below, we will use action tuple and percept-action pair interchangeably. Each action tuple keeps reliability and novelty statistics for its associated percept and the percept's children. Reliability models the correlation between an action tuple being rewarded and a percept being active (in an overlapping temporal window). The novelty statistic reflects the relative frequency of the event of the percept being active; a novel percept is one has been rarely active. These statistics are used by the system to guide the exploration of potentially useful states by identifying more specific percepts that seem correlated with an increased reliability of the action in producing reward.

Mirroring our hierarchical representation of state, action tuples that invoke the same action but that depend on different percepts are organized hierarchically according to the specificity of the percept. When a transition between active actions occurs, we perform credit assignment and the outgoing action chooses its “best” action tuple to receive credit. For this approach to work, we need a metric to determine the “best” candidate for credit assignment. This need not be the percept-action pair that actually performed the action. Instead, we find the percept-action pair with the same action, but with a percept that was not only active, but also the most reliable, novel and specific. We search for this pair within a temporal window overlapping with the action performed by some specified amount. This is illustrated in FIG. 3. Similarly, during action selection, each action gets to choose its “best” action tuple to compete with the “best” action tuples associated with other actions.

In the example shown in FIG. 3, the <“true”/sit> action tuple delegates credit to <“sit-utterance”/sit> since the “sit-utterance” percept became active during the attention window (cross-hatched bar) associated with <“true”/sit> and is a more novel and reliable predictor of reward than “true”. By allowing the credit assignment phase to choose who gets credit we can dramatically simplify the learning and training process, as we will see in the section on action space discovery. We use percept-action pair rather than state-action pair to remind the reader that an action tuple makes its “when decision” based on a subset of the entire state of the world as indicated by its “when” percept.

Reward

An action tuple may have good, indifferent or bad consequences. Consequences are expressed on an absolute scale, and certain events are labeled a priori as being “good” or “bad”.

Key Processes

Credit Assignment

Our approach to credit assignment varies from the traditional RL approach in a number of ways:

Delegate credit assignment. The action tuple that is deactivating and normally the candidate for credit assignment has the option to delegate credit assignment to another action tuple. This is perhaps the most significant difference and plays an important role in our algorithm.

Selective propagation of value. The key implication of the bias to learn immediate consequences is that we do not prop-agate value unless a good or bad consequence is observed, or unless the novelty of the percept associated with the succeeding action tuple is above a threshold. The intuition is that the percept-action pair should only get credit if it produced re-ward or if it seems causal in making a novel percept active, thereby allowing another potentially more valuable percept-action pair to become active.

A rate-based model. In traditional RL, the scalar value of a state-action pair tends towards the average value of performing that action in that state. An action tuple, on the other hand, explicitly learns a model of its rate of producing reward; ultimately, its value is a function of this learned rate and the value assigned to the consequences. During credit assignment, an action tuple updates a model of its rate of producing reward based on consequence.

Non-stationary estimate. The rate of producing a significant consequence is estimated over the most recent N trials, where N is typically a small number. Should the world change, a creature can rapidly update its rate estimates and adapt to the changes. Trials are measured in the number of activations of the action tuple that led to a reward. Hence, they are variable in length, reflecting the pattern of rewards.

The most important reason for using a rate-based model is that by maintaining an explicit model of rate, the action tuple is able to inform the rest of the system whether a consequence is consistent with its model or not, and hence expected or unexpected. For example, this information can be used by a proto-emotion system to decide whether the creature should show surprise or not, and if so, whether the surprise should be positive or negative.

State-Action Space Discovery

State-action space discovery is the process of discovering the best percept-action pair to perform in any given state. In our earlier discussion of RL, we saw that the set of state-action pairs is typically specified a priori and the task for the learning algorithm is to exhaustively explore the space and learn the appropriate value for each pair. Our hierarchical representation of state allows us to adopt a different approach-the system is initially populated with only a few percept-action pairs (i.e., action tuples) that represent general world states (i.e., reference percepts at the top of the percept tree). Over time, new percept- action pairs are added as the system gathers evidence that a promising action associated with a given state might be made even more reliable if associated with a more specific child of the state. This process of creating new children action tuples is referred to as specialization. At the same time, of course, the system must learn the appropriate value for the percept-action pairs. The advantage of this approach is twofold. First, the system only explores areas of the space for which there is evidence of possible improvement. Second, fewer resources are required when action tuples are not created a priori. In this section, we discuss how specialization occurs.

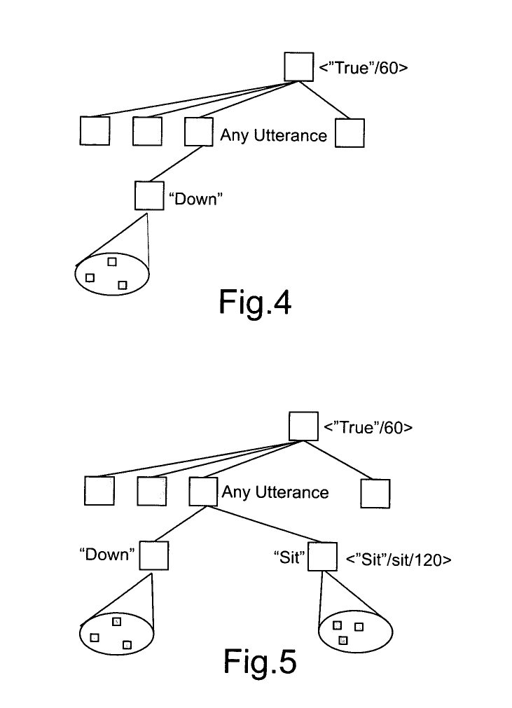

FIGS. 4 and 5 illustrates the process of state-action space discovery. In FIG. 4, the trainer begins by rewarding the performance of <“true”/sit>, with the effect being that the reliability and value of <“true”/sit> increases. This in turn increases the frequency of sitting. Once the dog is sitting frequently, the trainer starts saying “sit” as the sit action is performed, while continuing to reward the sit. As the trainer continues this process, the system begins to build a classifier for the specific utterance that occurs during the attention window associated with rewarded sits, and eventually spawns a <“sit-utterance”/sit> percept-action pair. Over time the trainer will stop rewarding spontaneous sits or sits in response to other utterances (i.e., <“true”/sit> or <“any-utterance”/sit>). The effect is that the reliability (and value) of these action tuples will drop in comparison with that of <“sit-utterance”/sit> and these less specific and reliable action tuples are expressed less frequently. During the credit assignment phase, the percept-action pair selected for credit assignment has the option of specializing. Two conditions must be met to be eligible for specialization. First, the value of the percept-action pair must be over some threshold. That is, there needs to be some evidence that the percept-action pair or a variant is potentially valuable. Second, the percept must have a child whose reliability and novelty is above a certain threshold. These statistics essentially provide evidence that a new percept-action pair utilizing that child percept could be more reliable than a percept-action pair relying on the parent percept. If these conditions are met then a new child of the parent percept-action pair is created with the same action as the parent, but with the percept's child. Once added to the parent, it becomes eligible to be selected as the most appropriate representative of all of the percept-action pairs that share its action. The process of specialization is illustrated in FIGS. 4 and 5. The mechanism described above provides a simple hierarchical search of the state-action space, focusing on those areas that seem most promising and exploring variants of percept-action pairs for which there is evidence that a variant may prove more valuable than its parent.

State Space Discovery

As suggested above, there are important advantages to integrating state space discovery into the learning process. For example, assume a creature is to be taught to perform tricks in response to arbitrary acoustic patterns (utterances, whistles, etc.) If state-space discovery is being performed the only acoustic patterns that need be considered are (a) those that are actually experienced and (b) those for which there is some evidence that they matter with respect to the creature's goals.

An unsupervised technique such as k-means clustering can be employed to partition the observed patterns into distinct clusters or classes. See THERRIEN, C., Decision Estimation and Classification: An Introduction to Pattern Recognition and Related Topics. John Wiley and Sons, New York, N.Y. 1989. In this case, each cluster or class represents a region of the state space. K-means clustering partitions observed patterns into k clusters such that the distance between the center of a cluster and all of the observations that comprise that cluster is minimized across all clusters and patterns. This algorithm is an example of unsupervised learning since the clusters emerge from the data without any supervisory signal providing feedback.

Our experience with dog learning suggests a different approach: treat all patterns that occur contemporaneously with an action that directly leads to a significant outcome (i.e., a reward) as belonging to the same cluster. The action itself becomes the label for the cluster and the reward acts as a natural supervisory signal that indicates if the pattern is a good example either of the cluster in which it was classified (and so should be included in the cluster) or as a seed for a new cluster. This idea is incorporated into the algorithm used in our system, a variation on an incremental k-nearest neighbors technique. See Ivanov 2001, supra. For example, in the case of acoustic processing, there is a percept that recognizes the presence of acoustic patterns, and each of its children percepts represent a cluster of similar patterns. The child percepts are created dynamically as follows: When an acoustic pattern is observed, the acoustic pattern percept and its children responsible for classifying acoustic patterns will attempt to find a match. If a match is found, the associated percept becomes active.

If the percept becomes active, the active percept-action pair may change if the percept is referenced by another existing percept-action pair, and if that pair is more reliable in producing good consequences.

The pattern is stored in short-term memory.

The matching percept's model of the pattern is subsequently updated during credit assignment if:
(a) The deactivating percept-action pair is directly followed by good consequences.
(b) The percept is a child of the deactivating percept-action pair's percept and it became active during the percept-action pair's attention window.
(c) The observation was not classified by one of the percept's children, but 4a) is true. In this case the percept may create a new child and initialize the child's model with the observation as its first sample.

Update reliability statistics For example, assume that initially the acoustic pattern percept has no children, and there is a <“true”/sit> percept-action pair (i.e., “sit”) that periodically becomes active. Now suppose that the acoustic pattern percept repeatedly becomes active in the context of a “sit” that consistently leads to a reward. The first time this occurs, it will create a new child percept and initialize it with the pattern that activated it. Every subsequent time that a pattern is detected in the context of a rewarded “sit”, that child percept will update its model using the observed pattern. As the child starts classifying incoming patterns correctly (according to its model) within the context of a rewarded “sit”, its reliability will increase. Finally, as a result of specialization, when its reliability rises above a threshold, a new percept-action pair will be created, i.e., <“sit”/sit>.

While simple, this algorithm captures what is necessary to learn the kinds of acoustic cues that dogs seem capable of learning. In addition, Ivanov [Ivanov 2001; Ivanov et al. 2001] has explored these ideas more formally and has shown how this simple idea can be incorporated into the well-known Expectation-Maximization learning algorithm as well as SVM. (See IVANOV, Y., BLUMBERG, B., AND PENTLAND, A. 2001, Expectation maximization for weakly labeled data, Proceedings of the 18th International Conference on Machine Learning, for a detailed discussion of the algorithm used to perform clustering and classification, as well as clustering with a reduced set of examples.

Action Space Discovery

As suggested above, we can perform action space discovery using almost the same approach as taken for state space discovery. This simplification is made possible by our representation of action (labeled paths through pose space) and by the existence of motor-percepts that can classify a path just taken as being either an example of an existing path or a novel path. Since action space discovery occurs as a result of luring and shaping, how- ever, we need additional machinery. Specifically, luring requires (a) a “follow-your-nose” motor program, (b) a “motor memory” that continuously records recent poses that have been visited and (c) the modification to the credit assignment rule as suggested above. Even though “follow-your-nose” may directly precede a reward, the algorithm can give the credit to another action whose associated path is close to that just taken. Using this idea, the algorithm for performing action space discovery that supports luring is straightforward. When assigning credit (at an action's end):

1. If the creature received a direct reward, compare the path taken to known paths:
(a) If the path is similar to an existing path, then reward the action associated with that path (i.e., give it the credit) and update the model of the rewarded path using the path just taken as a new example.
(b) If the path is novel (not well captured by some other action), then create a new motor percept and initialize its model using the path just taken.

2. If no reward is received, ignore the path.

Once a motor-percept is added to the percept tree, reliability statistics are kept just as in the case of other percepts. When a motor-percept's reliability gets above a threshold, a new action tuple is created that uses the motor-percept's path model as its action. Once this is done, the action tuple is a candidate for specialization and can explore to find the context in which it is maximally reliable.

Another kind of motor learning in animals that we have noted is shaping. In our system we adopt a parameterized approach. That is, if the action can be parameterized (e.g., the amplitude of “shake-paw”) the parameters can be drawn from a local probability distribution that reflects the pattern of rewards. When an action is about to be performed, a value for the parameter is chosen probabilistically. If the action is subsequently rewarded, the probability distribution is adjusted to make it more likely in the future that a value near the chosen value will be selected. If the action is not rewarded, the probability distribution is either left unchanged or adjusted to make it less likely that a similar value will be chosen in the future.

Results and Discussion

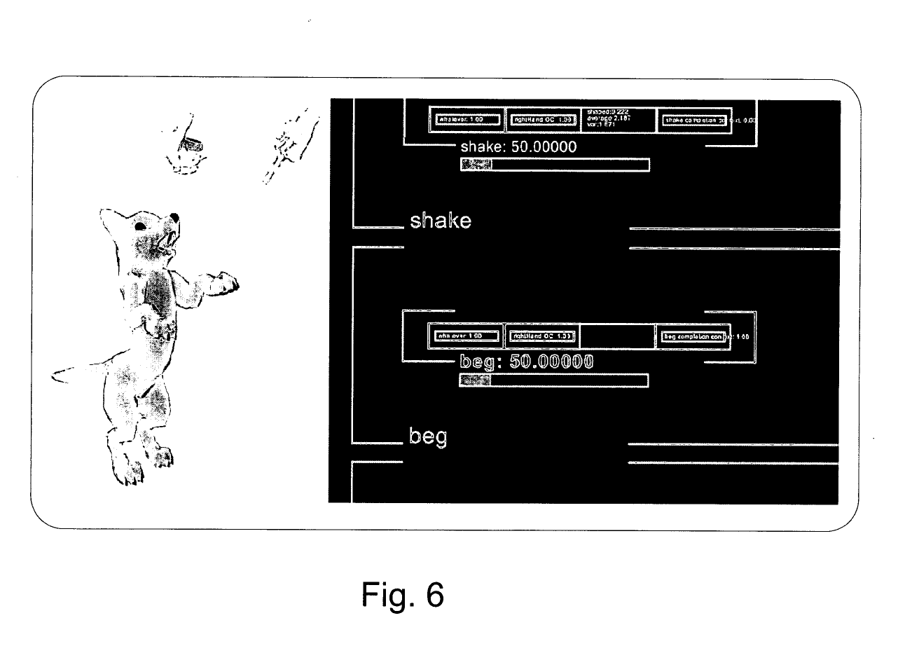

The system described above has been incorporated into a general-purpose behavior architecture of type described in the following papers: (1) BURKE, R., ISLA, D., DOWNIE, M., IVANOV, Y., AND BLUMBERG, B. Creature smarts: The art and architecture of a virtual brain. In Proceedings of the Computer Game Developers Conference, 2001; and ISLA, D., BURKE, R., DOWNIE, M., AND BLUMBERG, B., A layered brain architecture for synthetic creatures. In Proceedings of The International Joint Conference on Artificial Intelligence, 2001. As seen in FIG. 6, we demonstrate some aspects of clicker training and luring on our synthetic pup, as discussed above and further illustrated in FIG. 1.

On the left in FIG. 6, we see Dobie performing a Beg. On the right, an example of our action tuple visualizer. Initially, the pup experiments among its known actions. As the trainer preferentially rewards sitting, the frequency of sitting increases. When sitting is performed reliably, the trainer starts giving the verbal cue “sit” as the pup begins to sit, while also reducing the rate of reinforcement if the pup sits in the absence of the cue. The system, through state space discovery, creates a new percept that contains a model of the (arbitrary) acoustic pattern associated with the rewarded sit and adds it to the pup's percept tree. Eventually, a new percept-action pair is created that represents <“sit”/sit>. At the same time, we see that the frequency of spontaneous sitting decreases.

Next, we demonstrate simple luring of the dog by moving the target hand over the dog's head and clicking as he gets into the sit pose. We also illustrate the more complex example of luring the dog through a novel trajectory—in this case, walking in an ‘S’ pattern on the ground. When rewarded, this lured trajectory is added to the action space as a new action (through action space discovery), and can thus be associated with a cue and can be selected randomly by the pup in the future just like any of the previously known actions.

Finally, we demonstrate shaping. The pup experiments with different forms of his parameterized “shake-paw” action. The trainer rewards ever higher versions of the shakeaction until the pup shakes his paw high reliably. 5.1 Limitations and Future Work Our system has a number of important limitations and areas for future work:

The system is biased to learn immediate consequences rather than extended sequences. Nonetheless, learning sequences is important, and we will be addressing this area in our future work.

The system does not address spatial and social learning. Our sense is that while much can be shared across learning tasks, it is very likely that the right solution will have specialized mechanisms and representations for specific learning tasks. (See [Isla 2001] for an example of spatial learning.)

There are things the system should be able to learn which it cannot—for example, states that are conjunctions or disjunctions of percepts. In addition, it cannot generalize from specific percepts to more general ones. These, however, are hard problems. An easier problem, and one that has been addressed by a variant of the system discussed here, is to learn important correlations among events that enable the creature to act proactively. See BURKE, R. 2001, Its about Time: Temporal Representation for Synthetic Characters, Master's thesis, The Media Lab, M.I.T.

The existence, speed and quality of classifiers, such as our utterance or path classifiers, are critically important to the functioning of the system, but we have only touched on them briefly here. While our integrated approach helps the classifiers build better models, more could be done. For example, the classifiers do not currently make use of negative examples. (See IVANOV, Y. 2001, State Discovery for Autonomous Creatures. PhD thesis, The Media Lab, MIT., for an indepth discussion of this topic.)

How will the system scale? We feel that our integrated approach as well as our hierarchical representations of the learning spaces will allow our system to scale better than a traditional RL system, but more work needs to be done to support this claim.

Useful Insights

While our results are from a specific learning system, there are a number of ideas that we believe are generally useful in the context of learning for synthetic characters, regardless of the specifics of the implementation.

Use temporal proximity to limit search. We utilize a temporal attention window that overlaps the beginning of an action to identify potentially relevant states. Similarly, we generally assign credit to the action that immediately precedes a motivationally significant event.

Use hierarchical representations of state, action and state-action space. We utilize loosely hierarchical representations of state, action and state-action space and use simple statistics to identify potentially promising areas of the respective spaces for exploration. We grow these hierarchies downward toward more fine-grained representations of state and more specific (and hopefully more reliable) state-action pairs.

Use natural feedback signals to guide exploration of the three spaces. The practical effect in both cases is that fewer models are built, and those that are built tend to be more relevant and robust.

Bias frequency and variability of action so as to facilitate learning. This not only allows the creature to exploit what it knows, but also gives it more opportunities to discover more reliable variations.

Give credit where credit is due. The state-action pair that would normally receive credit should be given the option to delegate its credit to another, potentially more appropriate, state-action pair. We saw that this was particularly useful in the context of “luring”.

Conclusion

The present invention provides a practical approach to real-time learning for synthetic characters that allows them to learn the same kinds of things that dogs seem to learn so easily. We believe that by embedding dog-level learning into synthetic characters, we can provide them with a way to meaningfully adapt to human interaction. By addressing the three problems of state, action, and state-action space discovery at the same time, the solution for each be-comes easier. Similarly, by viewing learning and training as a coupled system we were able to gain valuable insights into each.

It is to be understood that the methods and apparatus which have been described above are merely illustrative applications of the principles of the invention. Numerous modifications may be made by those skilled in the art without departing from the true spirit and scope of the invention.

What is claimed is:

1. A method for training a mechanism to perform desired actions comprising, in combination,
storing state data specifying the attributes of each of a plurality of different environmental states in which said mechanism can exist,
storing action data specifying the attributes of each of a plurality of different actions that said mechanism may perform,
storing tuple data comprising a plurality of tuples each of which specifies a given one of said environmental states, a given one of said actions, and at least one utility value indicating the likelihood of achieving a desired outcome as a result of performing said given action when said given state exists,
storing current state condition data defining the attributes of the current environmental state of said mechanism;
accepting input stimulus data and modifying said current state condition data in response to said input stimulus data,
comparing said current state condition data with said tuple data to identify matching tuples which specify an environmental state corresponding to said current state condition,
selecting from said matching tuples the particular tuple having the highest utility value,
performing the action specified in said particular tuple if said highest utility value is greater than a specified threshold,
altering said utility value in said particular tuple to record the performance of said action, and
modifying said current state condition to reflect the performance of said action.

2. A method for training a mechanism to perform desired actions as set forth in claim 1 wherein said at least one utility value indicating the likelihood of achieving a desired outcome indicates the rate at which said desired outcome is achieved over a limited number of prior performances of said given action when said given state exists.

3. A method for training a mechanism to perform desired actions as set forth in claim 1 further including the step of organizing said state data into hierarchical parent-child groupings in which the data defining each specific child state is more specific than the data defining the parent state of said specific child state.

4. A method for training a mechanism to perform desired actions as set forth in claim 1 wherein said action data which specifies the attributes of a given action comprises the identification of a sequence of configurations assumable by said mechanism.
